(19) United States
(12) Patent Application Publication
(10) Pub. No.: US 2025/0245723 A1
(43) Pub. Date: Jul. 31, 2025

(54) SYSTEMS AND METHODS FOR ITEM RECOMMENDATIONS BASED ON DUAL MODELS

(71) Applicant: Walmart Apollo, LLC, Bentonville, AR (US)

(72) Inventors: Kaushiki Nag, Sunnyvale, CA (US); Murali Mohana Krishna Dandu, San Jose, CA (US); Lalitesh Morishetti, San Jose, CA (US); Sinduja Subramaniam, Sunnyvale, CA (US); Evren Korpeoglu, San Jose, CA (US); Kannan Achan, Saratoga, CA (US); Shree ranjani Srirangam Sridharan, San Jose, CA (US)

(21) Appl. No.: 18/428,989

(22) Filed: Jan. 31, 2024

(51) Int. Cl. G06Q 30/0601; G06Q 30/0201

(52) U.S. Cl. CPC G06Q 30/0631; G06Q 30/0201; G06Q 30/0625

(57) ABSTRACT

Systems and methods for providing item recommendations based on dual models with different levels of product data granularity are disclosed. In some embodiments, a disclosed method includes: receiving, from a computing device, a recommendation request for recommending items to a customer; determining, based on the recommendation request, at least one anchor item to be displayed to the customer; obtaining a first machine learning model trained based on a first product data granularity; obtaining a second machine learning model trained based on a second product data granularity; generating, using the first machine learning model and the second machine learning model, a ranked list of recommended items based on the at least one anchor item; and transmitting to the computing device the ranked list of recommended items to be displayed to the customer with the at least one anchor item.

### TECHNICAL FIELD

This application relates generally to item recommendations and, more particularly, to systems and methods for providing item recommendations based on dual models with different levels of product data granularity.

### BACKGROUND

Item recommendation tasks in e-commerce industry are essential to improve user experiences by recommending items to users. Existing e-commerce recommendation systems struggle with the vast and diverse array of products, making it challenging to train models efficiently and maintain accuracy in predictions. In addition, many existing systems tend to offer a narrow range of suggestions, often focusing on popular items, which leads to a lack of diversity in the recommendations provided to customers. As such, it is challenging yet desirable to provide more precise and contextually relevant recommendations that align closely with individual user preferences and shopping behaviors.

### SUMMARY

The embodiments described herein are directed to systems and methods for providing item recommendations based on dual models with different levels of product data granularity.

In various embodiments, a system including a non-transitory memory configured to store instructions thereon and at least one processor is disclosed. The at least one processor is operatively coupled to the non-transitory memory and configured to read the instructions to: receive, from a computing device, a recommendation request for recommending items to a customer; determine, based on the recommendation request, at least one anchor item to be displayed to the customer; obtain a first machine learning model trained based on a first product data granularity; obtain a second machine learning model trained based on a second product data granularity; generate, using the first machine learning model and the second machine learning model, a ranked list of recommended items based on the at least one anchor item; and transmit to the computing device the ranked list of recommended items to be displayed to the customer with the at least one anchor item.

In various embodiments, a computer-implemented method is disclosed. The computer-implemented method includes: receiving, from a computing device, a recommendation request for recommending items to a customer; determining, based on the recommendation request, at least one anchor item to be displayed to the customer; obtaining a first machine learning model trained based on a first product data granularity; obtaining a second machine learning model trained based on a second product data granularity; generating, using the first machine learning model and the second machine learning model, a ranked list of recommended items based on the at least one anchor item; and transmitting to the computing device the ranked list of recommended items to be displayed to the customer with the at least one anchor item.

In various embodiments, a non-transitory computer readable medium having instructions stored thereon is disclosed. The instructions, when executed by at least one processor, cause at least one device to perform operations including: receiving, from a computing device, a recommendation request for recommending items to a customer; determining, based on the recommendation request, at least one anchor item to be displayed to the customer; obtaining a first machine learning model trained based on a first product data granularity; obtaining a second machine learning model trained based on a second product data granularity; generating, using the first machine learning model and the second machine learning model, a ranked list of recommended items based on the at least one anchor item; and transmitting to the computing device the ranked list of recommended items to be displayed to the customer with the at least one anchor item.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for providing item recommendations based on dual models with different levels of product data granularity, in accordance with some embodiments of the present teaching;

FIG. 2 is a block diagram of an item recommendation computing device, in accordance with some embodiments of the present teaching;

FIG. 3 is a block diagram illustrating various portions of a system for providing item recommendations based on dual models with different levels of product data granularity, in accordance with some embodiments of the present teaching;

FIG. 4 illustrates an exemplary process for generating ranked item recommendation, in accordance with some embodiments of the present teaching;

FIG. 5 illustrates an exemplary process for generating a virtual catalog, in accordance with some embodiments of the present teaching;

FIG. 6 illustrates an exemplary process for mapping items to virtual item types, in accordance with some embodiments of the present teaching;

FIG. 7 illustrates an exemplary process for predicting next likely items, in accordance with some embodiments of the present teaching;

FIG. 8 illustrates exemplary lists of recommended product types, in accordance with some embodiments of the present teaching;

FIG. 9 is a flowchart illustrating an exemplary method for providing item recommendations based on dual models with different levels of product data granularity, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Sequential data may be generated based on behaviors of an online customer, e.g. a sequence of items clicked by the customer in a same user session, a sequence of items placed in a shopping cart by the customer, or a sequence of items purchased by the customer. One objective of the present teaching is to predict the next likely item in such a sequence and provide item recommendations accordingly. In some embodiments, a disclosed system utilizes a dual model strategy leveraging the strengths of transformer architectures to handle sequential data effectively. In addition, the system use a virtual catalog and additional item features to provide depth and precision to the recommendation process. The dual model setup ensures both accuracy through double validation and diversity in the item recommendations provided to customers.

In some embodiments, a system is disclosed to recommend items to customers by leveraging the sequential nature of shopping behavior primarily based on the cart context. The system utilizes two independent yet complementary transformer-based models, one for predicting product types and the other for predicting specific item clusters, to enhance the accuracy and relevance of recommendations by an agreement between both models for a product to be recommended. In some examples, each item cluster is a virtual item type or an imaginary item having a higher level of granularity than a product type.

In some embodiments, the system creates a virtual catalog of imaginary items or virtual item types using a machine learning model, e.g. a clustering model or a large language model, which can simplify the item space by semantically clustering items into broader and manageable categories which have a different granularity than existing product types. In addition, the system can implement a semantic mapping process that aligns actual items with their closest imaginary counterparts in the virtual catalog, thereby reducing the complexity of the item space.

In some embodiments, one or more filtering and/or review processes may be implemented at various stages to identify and/or prevent generation of undesirable content by the large language model or any other model. For example, one or more filtering processes may be applied to identify, remove, and/or otherwise eliminate undesirable content such as inappropriate content, offensive images, restricted images, etc. Although specific embodiments are discussed herein, it will be appreciated that any suitable filtering may be applied at any suitable steps of the disclosed methods.

In some embodiments, the system can employ a double validation mechanism where both models must agree for a product to be recommended, ensuring high-quality suggestions. As such, while the two models operate independently, their outputs are deeply integrated. For a recommendation to be made, both models must agree, e.g. one model deciding on the product type and the other model deciding on the specific item or item cluster.

In addition, the dual-model architecture not only ensures relevance, as both models must converge on a decision, but also promotes diversity of recommended items. By having two different perspectives, product types and item clusters (or virtual item types), the system can uncover diversified recommendations that might be overlooked by a single-model approach. Rather than recommending similar or popular items repeatedly, the disclosed system, with its integration of diversity-enhancing algorithms like a weighted maximal marginal relevance, ensures a wider range of products are suggested, thereby enhancing the user experience and potentially increasing exposure to a broader product range.

In some embodiments, the system skillfully balances the exploration of new, diverse items and the exploitation of items that are most likely to be relevant, ensuring that customers are exposed to both familiar and novel products. Further, the system is designed to continuously learn and adapt, incorporating user feedback and changing and evolving market trends.

Furthermore, in the following, various embodiments are described with respect to systems and methods for providing item recommendations based on dual models with different levels of product data granularity are disclosed. In some embodiments, a disclosed method includes: receiving, from a computing device, a recommendation request for recommending items to a customer; determining, based on the recommendation request, at least one anchor item to be displayed to the customer; obtaining a first machine learning model trained based on a first product data granularity; obtaining a second machine learning model trained based on a second product data granularity; generating, using the first machine learning model and the second machine learning model, a ranked list of recommended items based on the at least one anchor item; and transmitting to the computing device the ranked list of recommended items to be displayed to the customer with the at least one anchor item.

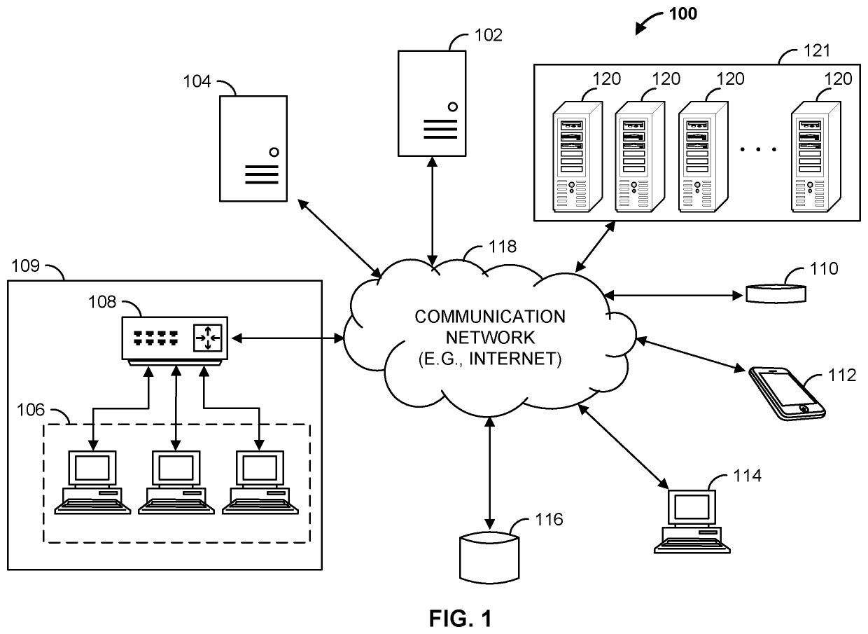

Turning to the drawings, FIG. 1 is a network environment 100 configured for providing item recommendations based on dual models with different levels of product data granularity, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, an item recommendation computing device 102, a server 104 (e.g., a web server or an application server), a cloud-based engine 121 including one or more processing devices 120, workstation(s) 106, a database 116, and one or more user computing devices 110, 112, 114 operatively coupled over the network 118. The item recommendation computing device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the item recommendation computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the item recommendation computing device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the item recommendation computing device 102, the processing devices 120, and/or the server 104 are operated by a retailer, and the multiple user computing devices 110, 112, 114 are operated by customers, associates and/or managers of the retailer. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the item recommendation computing device 102 over the communication network 118. The workstation(s) 106 may send data to, and receive data from, the item recommendation computing device 102. For example, the workstation(s) 106 may transmit data identifying items purchased by a customer at the store 109 to the item recommendation computing device 102. The workstation(s) 106 may also transmit other data related to the store 109 to the item recommendation computing device 102.

Although FIG. 1 illustrates three user computing devices 110, 112, 114, the network environment 100 can include any number of user computing devices 110, 112, 114. Similarly, the network environment 100 can include any number of the item recommendation computing devices 102, the processing devices 120, the workstations 106, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, each of the multiple user computing devices 110, 112, 114 may be operable to view, access, and interact with a website, such as a retailer's website, hosted by the server 104. The server 104 may capture user session data related to a customer's activity (e.g., interactions) on the website.

In some examples, a customer may operate one of the user computing devices 110, 112, 114 to initiate a web browser that is directed to the website hosted by the server 104. The customer may, via the web browser, view item advertisements for items displayed on the website, and may click on item advertisements, for example. The website may capture these activities as user session data, and transmit the user session data to the item recommendation computing device 102 over the communication network 118. The website may also allow the customer to add one or more of the items to an online shopping cart, and allow the customer to perform a “checkout” of the shopping cart to purchase the items. In some examples, the server 104 transmits purchase data identifying items the customer has purchased from the website to the item recommendation computing device 102.

In some examples, a customer may go to a store, e.g. the store 109 for purchasing items. The customer may use some payment method, e.g. a credit card or a payment app, at the store 109 to purchase one or more items. The workstation(s) 106 in the store 109 may capture these activities as in-store purchase data, and transmit the in-store purchase data to the item recommendation computing device 102 over the communication network 118, together with other store related data.

In some examples, the item recommendation computing device 102 may receive a recommendation request for recommending items to a customer of a retailer from the server 104. The recommendation request may be sent standalone or together with data associated with the customer's interaction with a website of the retailer, e.g. an anchor item to be displayed to the customer via the website or a user interface. In response, the item recommendation computing device 102 generates a ranked list of recommended items based on the anchor item using one or more models.

In some examples, the item recommendation computing device 102 may execute one or more models (e.g., programs or algorithms), such as a machine learning model, deep learning model, statistical model, etc., to generate a ranked list of recommended items to advertise to the customer (i.e., item recommendations). The item recommendation computing device 102 may generate and transmit the item recommendations to the server 104 over the communication network 118, and the server 104 may display one or more of the recommended items on the website to the customer. For example, the server 104 may display the recommended items to the customer on a homepage, a cart page, a catalog webpage, an item webpage, a search results webpage, or a post-transaction webpage (e.g. a thank you page) of the website (e.g., as the customer browses those respective webpages).

In one example, a customer selects an item on a website hosted by the server 104, e.g. by clicking on the item to view its product description details, by adding it to shopping cart, or by purchasing it. The server 104 may treat the item as an anchor item or query item for the customer, and send a recommendation request to the item recommendation computing device 102. In response to receiving the request, the item recommendation computing device 102 may execute the one or more processors to determine recommended items that are related to the anchor item and can increase product diversity, and transmit the recommended items to the server 104 to be displayed together with the anchor item to the customer.

In another example, a customer submits a search query on a website hosted by the server 104, e.g. by entering a query in a search bar. The server 104 may send a recommendation request to the item recommendation computing device 102. In response to receiving the request, the item recommendation computing device 102 may execute the one or more processors to first determine search results including items matching the search query, and then determine recommended items that are related to one or more top items in the search results and can potentially increase product diversity. The item recommendation computing device 102 may transmit the recommended items to the server 104 to be displayed together with the search results to the customer.

In some embodiments, the item recommendation computing device 102 is further operable to communicate with the database 116 over the communication network 118. For example, the item recommendation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the item recommendation computing device 102, in some examples, the database 116 can be a local storage device, such as a hard drive, a non-volatile memory, or a USB stick. The item recommendation computing device 102 may store online purchase data received from the server 104 in the database 116. The item recommendation computing device 102 may receive in-store purchase data and store related data from the store 109 and store them in the database 116. The item recommendation computing device 102 may also receive from the server 104 user session data identifying events associated with browsing sessions, and may store the user session data in the database 116. The item recommendation computing device 102 may also compute recommendation data related to a ranked list of recommended items, and may store the recommendation data in the database 116.

In some examples, the item recommendation computing device 102 generates and/or updates different models (e.g., machine learning models, deep learning models, statistical models, algorithms, etc.) for providing item recommendations based on dual models with different levels of product data granularity. The item recommendation computing device 102 may generate training data for the models based on historical user session data, purchase data, real and virtual catalog data, and simulated labels. The item recommendation computing device 102 trains the models based on their corresponding training data, and stores the models in a database, such as in the database 116 (e.g., a cloud storage). The models, when executed by the item recommendation computing device 102, allow the item recommendation computing device 102 to determine item recommendations for one or more items to advertise to a customer.

In some examples, the item recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the item recommendation computing device 102 may generate ranked item recommendations for items to be displayed on the website.

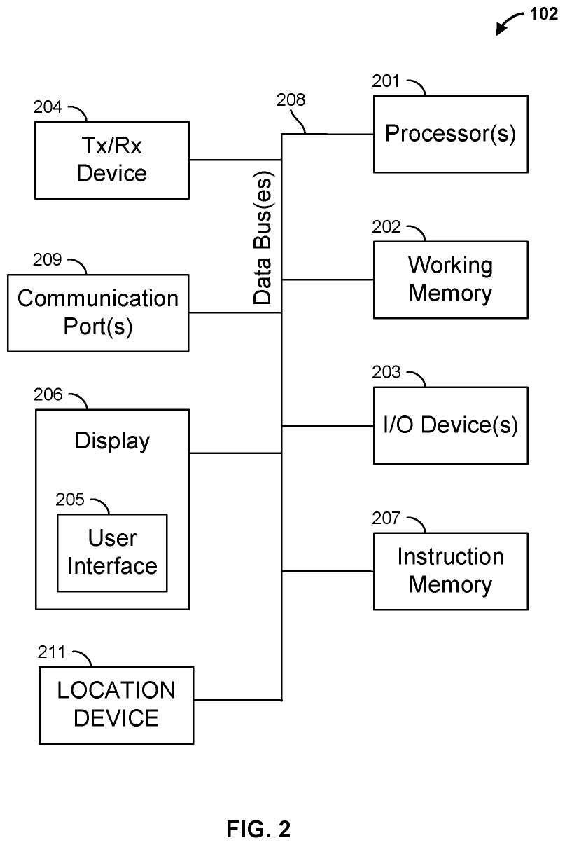

FIG. 2 illustrates a block diagram of an item recommendation computing device, e.g. the item recommendation computing device 102 of FIG. 1, in accordance with some embodiments of the present teaching. In some embodiments, each of the item recommendation computing device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the item recommendation computing device 102 can be combined, omitted, and/or replicated. In addition, it will be appreciated that additional elements other than those illustrated in FIG. 2 can be added to the item recommendation computing device 102.

As shown in FIG. 2, the item recommendation computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the item recommendation computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the item recommendation computing device 102 can include a single memory unit configured to operate as both instruction memory and working memory. Further, although embodiments are discussed herein including non-volatile memory, it will be appreciated that the item recommendation computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the item recommendation computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the item recommendation computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the item recommendation computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11 a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the item recommendation computing device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the item recommendation computing device 102 may determine a local geographical area (e.g., town, city, state, etc.) of its position.

In some embodiments, the item recommendation computing device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

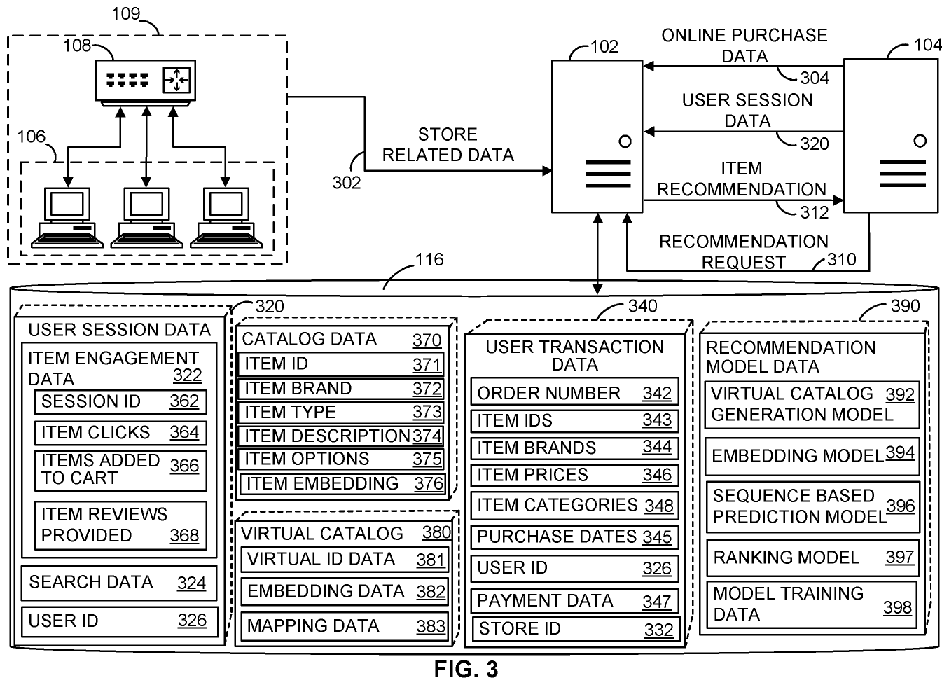

FIG. 3 is a block diagram illustrating various portions of a system for providing item recommendations based on dual models with different levels of product data granularity, e.g. the system shown in the network environment 100 of FIG. 1, in accordance with some embodiments of the present teaching. As indicated in FIG. 3, the item recommendation computing device 102 may receive user session data 320 from the server 104, and store the user session data 320 in the database 116. The user session data 320 may identify, for each user (e.g., customer), data related to that user's browsing session, such as when browsing a retailer's webpage hosted by the server 104.

In some examples, the user session data 320 may include item engagement data 322, search data 324, and user ID 326 (e.g., a customer ID, retailer website login ID, a cookie ID, etc.). The item engagement data 322 may include one or more of a session ID 362 (i.e., a website browsing session identifier), item clicks 364 identifying items which a user clicked (e.g., images of items for purchase, keywords to filter reviews for an item), items added-to-cart 366 identifying items added to the user's online shopping cart, provided item reviews 368 identifying product reviews provided by users. The search data 324 may identify one or more searches conducted by a user during a browsing session (e.g., a current browsing session).

The item recommendation computing device 102 may also receive online purchase data 304 from the server 104, which identifies and characterizes one or more online purchases, such as purchases made by the user and other users via a retailer's website hosted by the server 104. The item recommendation computing device 102 may also receive store related data 302 from the store 109, which identifies and characterizes one or more in-store purchases. In some embodiments, the store related data 302 may also indicate other information about the store 109.

The item recommendation computing device 102 may parse the store related data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding online orders, and store ID 332 for the corresponding in-store purchase, or for the pickup store or shipping-from store associated with the corresponding online purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), item options 375 (e.g., item colors, sizes, flavors, etc.), and item embedding 376 representing the item in an embedding space.

The database 116 may also store virtual catalog data 380 identifying and characterizing a plurality of virtual items or virtual item types in a virtual catalog. The virtual catalog data 380 may identify, for each of the plurality of virtual items, virtual ID data 381 identifying a virtual ID and other metadata for the virtual item, embedding data 382 identifying an embedding representing the virtual item in an embedding space, and mapping data 383 identifying a mapping between the virtual item and a set of actual items, and/or a mapping between the virtual item and a product type.

The database 116 may also store recommendation model data 390 identifying and characterizing one or more models and related data for providing item recommendations. For example, the recommendation model data 390 may include: a virtual catalog generation model 392, an embedding model 394, a sequence based prediction model 396, a ranking model 397, and model training data 398.

The virtual catalog generation model 392 may be used to generate a virtual catalog based on product types and actual item IDs. In some embodiments, the virtual catalog includes virtual item types that have a data granularity level between the product types and actual item IDs. For example, a product type includes one or more virtual item types; and a virtual item type includes one or more item IDs corresponding to one or more actual items respectively. In some embodiments, the virtual catalog generation model 392 includes a large language model. In some embodiments, the large language model is utilized to generate the virtual item types based on generation prompts including information about an actual item catalog.

The embedding model 394 may be used to compute an embedding for a text data. In some embodiments, the embedding model 394 is used to compute an item embedding for an actual item based on textual data (e.g. item title, product type and category information) of the actual item. In some embodiments, the embedding model 394 is also used to compute a virtual item embedding for a virtual item type based on textual data (e.g. product description, product type and category information) of the virtual item type. In some embodiments, the virtual item embeddings for virtual item types and the item embeddings for actual items are all located in a same embedding space. As such, a semantic similarity score between an item embedding and a virtual item embedding can be determined based on their distance in the embedding space, where a closer distance would indicate a higher similarity between the two embeddings and therefore a higher similarity between the corresponding items.

The sequence based prediction model 396 may be used to predict next likely items in a sequence. In some embodiments, the sequence based prediction model 396 includes one or more transformer-based machine learning models to predict next items at different levels of granularity. In some examples, the sequence based prediction model 396 includes a first transformer model utilized to predict next product types in a sequence, and includes a second transformer model utilized to predict next virtual item types in the sequence. Since a model at item ID level may miss the high level patterns, the models at the levels of product types and virtual item types can understand better the prediction by filtering out the noises at the item ID level.

The dual model structure can help to improve accuracy and diversity of item recommendation. The first transformer model for predicting next product types may be more accurate but not more precise compared to the second transformer model for predicting next virtual item types. In some embodiments, the sequence based prediction model 396 not only predicts a list of next likely items (at different granularity levels), but also provides a likelihood score for each item in the list to represent a probability that a customer will enable the item placed as next item in the sequence.

The ranking model 397 may be used to rank recommended items based on both lists of next likely items at different granularity levels: e.g. a first list of product types each with a corresponding likelihood score representing a probability that the customer will enable an item of the respective product type placed as next item in the sequence, and a second list of virtual item types each with a corresponding likelihood score representing a probability that the customer will enable an item of the respective virtual item type placed as next item in the sequence. In some examples, the ranking model 397 includes a weighted maximal marginal relevance model that merges the two lists to generate a ranked list of recommended items based on the likelihood scores and a predetermined weight that balances relevance and diversity. In some embodiments, the ranking model 397 may first generate a ranked list of product types, and then map each product type in the list to a corresponding actual item based on a time-adaptive mapping rule or model.

The model training data 398 may include training data utilized for training one or more of the virtual catalog generation model 392, the embedding model 394, the sequence based prediction model 396 and the ranking model 397. In some examples, the model training data 398 may include, but not limited to, data related to a plurality of item sequences each including a series of anchor samples and a recommendation sample associated with a label score. The label score may be determined based on historical interaction data of a plurality of customers regarding the recommendation sample. The model training data 398 may be used to train a machine learning model to optimize an objective function based on optimized hyperparameters. In some examples, the optimized hyperparameters include weights for combining two item lists at different granularity levels. In some examples, the objective function is computed based on a plurality of ranking differences each being a difference between a first ranking and a second ranking for a respective series of anchor samples. Each of the first ranking and the second ranking is a ranking of the recommendation samples paired to the respective anchor sample. The first ranking of the recommendation samples is determined based on the machine learning model being trained. The second ranking of the recommendation samples is determined based on their respective label scores.

In some examples, the item recommendation computing device 102 receives a recommendation request 310 from the server 104. The recommendation request 310 may be associated with at least one anchor item or query item to be displayed to a user. In some embodiments, the item recommendation computing device 102 may obtain a first machine learning model trained based on a first product data granularity, and obtain a second machine learning model trained based on a second product data granularity. Based on the at least one anchor item, the item recommendation computing device 102 may generate, using the first machine learning model and the second machine learning model, item recommendation 312 indicating a ranked list of recommended items. The first machine learning model and the second machine learning model may include any model in the recommendation model data 390. In response to the recommendation request 310, the item recommendation computing device 102 transmits the item recommendation 312 to the server 104 to be displayed to the customer with the at least one anchor item.

In some embodiments, the item recommendation computing device 102 may assign one or more of the above described operations to a different processing unit or virtual machine hosted by one or more processing devices 120. Further, the item recommendation computing device 102 may obtain the outputs of the these assigned operations from the processing units, and generate the ranked item recommendations based on the outputs.

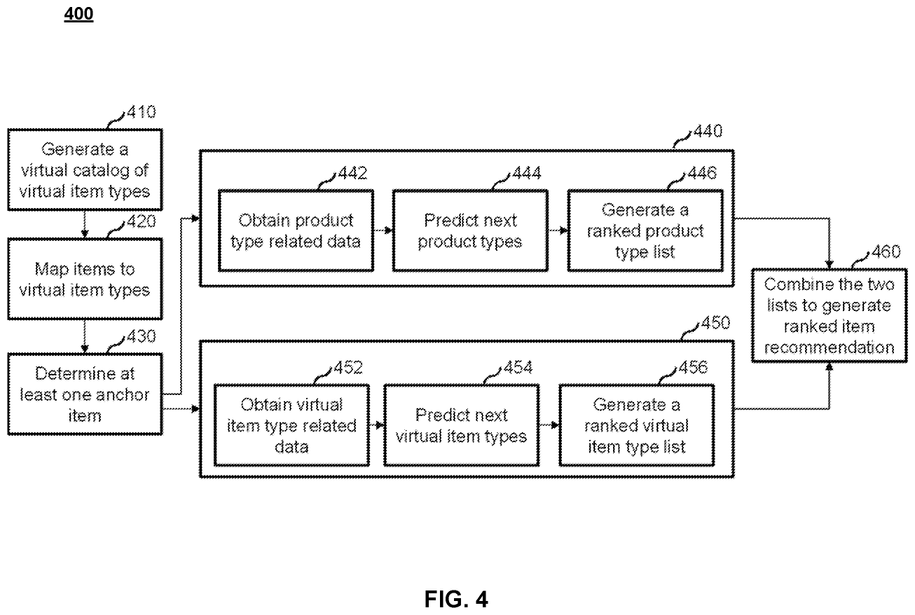

FIG. 4 illustrates an exemplary process 400 for generating ranked item recommendation, in accordance with some embodiments of the present teaching. In some embodiments, the process 400 can be carried out by one or more computing devices, such as the item recommendation computing device 102, and/or the cloud-based engine 121 of FIG. 1.

As shown in FIG. 4, the process 400 starts from operation 410, where a virtual catalog of virtual item types is generated. In some embodiments, because a big retailer can have millions of active items offered for sale, direct modeling on such complex item space is very challenging. In addition, a big percentage of these items may become out of stock or get changed via catalog data, generating noises for data processing. As such, it is better to perform sequence prediction and item recommendation at a granularity level higher than each actual item ID, to remove those noises.

In some embodiments, a retailer may already have items organized in product types, which is a very high level to get nuanced idea of the items. While the item recommendation based on sequential data can be performed at the granularity level of product types, it is better to perform item recommendation based on sequential data at a different granularity level as well. This is why the operation 410 is performed here to generate a virtual catalog.

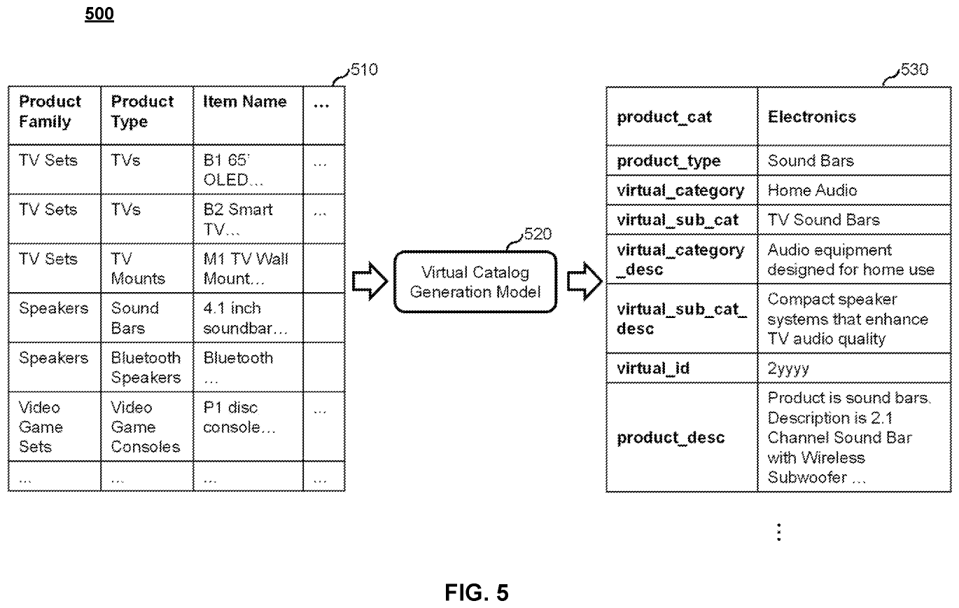

FIG. 5 illustrates an exemplary process 500 for generating a virtual catalog, in accordance with some embodiments of the present teaching. In some embodiments, the process 500 can be carried out by one or more computing devices, such as the item recommendation computing device 102, and/or the cloud-based engine 121 of FIG. 1. In some embodiments, the process 500 may be a detailed process of the operation 410 in FIG. 4.

As shown in FIG. 5, a table 510 represents an existing product catalog for the product category of Electronics. The table 510 can be used as an input to a virtual catalog generation model 520 to generate a virtual catalog. In some embodiments, the virtual catalog generation model 520 is part of the virtual catalog generation model 392 in FIG. 3. In some embodiments, the virtual catalog generation model 520 is a large language model. The table 510 can be used to generate a prompt for the large language model to generate the virtual catalog in a desired format, including virtual items. In some examples, the large language model is tasked with generating descriptions, titles and identifiers for imaginary items or virtual items. These items do not exist in the actual inventory but represent a broader category or archetype of products available.

FIG. 5 shows a table 530 illustrating an exemplary virtual item in the virtual catalog. The virtual item in the table 530 represent a set of actual items under the product type of “Sound Bars” in the product category of Electronics. The virtual item in the table 530 is under a virtual category “Home Audio” and a virtual sub-category “TV Sound Bars” in the virtual category. That is, the virtual item represent a virtual type of actual items under the “TV Sound Bars” virtual category with corresponding descriptions as shown in the table 530. The virtual item can be called a virtual item type which has a granularity level higher than product types, and lower than the actual item IDs.

Referring back to FIG. 4, at operation 420, the actual items are mapped to the virtual item types in the generated virtual catalog. As discussed above, when a virtual item type (e.g. the one represented by the table 530) is generated, the virtual item type is associated with a corresponding product type in the actual item catalog. As such, a first mapping can be created between the product types and the virtual item types in the virtual catalog. But a second mapping also needs to be created between the actual item IDs and the virtual item types in the virtual catalog.

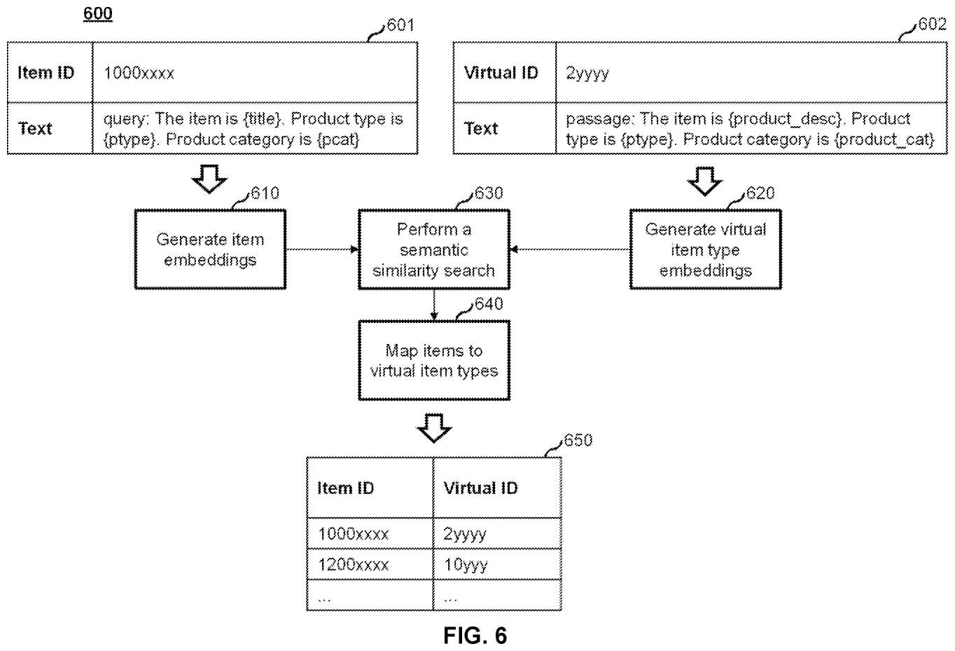

FIG. 6 illustrates an exemplary process 600 for mapping items to virtual item types, in accordance with some embodiments of the present teaching. In some embodiments, the process 600 can be carried out by one or more computing devices, such as the prediction data computing device 102, and/or the cloud-based engine 121 of FIG. 1. In some embodiments, the process 600 may be a detailed process of the operation 420 in FIG. 4.

As shown in FIG. 6, a table 601 represents an actual item with a corresponding item ID and corresponding textual data like item title, product type, product category, etc. In addition, a table 602 represents a virtual item type with a corresponding virtual ID and corresponding textual data like virtual product description, product type, product category, etc.

At operation 610, an item embedding is generated in an embedding space for each given actual item, e.g. the item represented by the table 601. In some examples, the item embedding may be generated using the embedding model 394 at the operation 610 based on textual information in the table 601. At operation 620, a virtual item embedding is generated in the embedding space for each given virtual item type, e.g. the virtual item type represented by the table 602. In some examples, the virtual item embedding may be generated using the embedding model 394 at the operation 620 based on textual information in the table 602. In some embodiments, the operations 610, 620 can be performed separately and independently, to generate item embeddings for actual items and virtual item embeddings for virtual item types, respectively.

Then at operation 630, a semantic similarity search is performed between the item embeddings and the virtual item embeddings. In some embodiments, the semantic similarity search can align actual items with their closest imaginary counterparts in the virtual catalog, thereby reducing the complexity of the item space. In some examples, for each actual item with a corresponding item ID and a corresponding item embedding, a semantic similarity score is computed at the operation 630 between the corresponding item embedding and each virtual item embedding in the embedding space to generate a plurality of semantic similarity scores. In some embodiments, the semantic similarity score is computed based on a cosine similarity or another distance metric between two embeddings. Among the plurality of semantic similarity scores, a highest semantic similarity score is determined between the item embedding and a top virtual item embedding.

The actual item with the corresponding item ID can be mapped at operation 640 to a virtual item type having the top virtual item embedding and a corresponding virtual ID. As such, after operations 630, 640, each item ID corresponding to an actual item is mapped to a virtual ID corresponding to a virtual item type, as shown in table 650. Accordingly, the actual items in a real catalog are mapped to the virtual item types in the virtual catalog.

In some embodiments, because the actual items are more granular than the virtual item types, multiple actual items may be mapped to a same virtual item type. In some embodiments, the mapping between the actual items and the virtual item types ensures that the item ID and virtual ID in each mapped pair are associated with a same product type.

Referring back to FIG. 4, in some embodiments, the models related to virtual catalog generation at the operation 410 and item mapping at the operation 420 are designed to learn and adapt continuously. For example, based on customer interactions, feedback, and changes in the actual inventory, a large language model can periodically update the virtual catalog. This ensures that the virtual categories and virtual item types remain relevant and accurately reflect emerging trends and consumer preferences.

At operation 430 in FIG. 4, at least one anchor item is determined, e.g. based on a recommendation request. For example, after a customer places one or more items in a shopping cart online, the customer clicks the shopping cart to view its content in a cart page. This click can trigger the recommendation request sent from the server 104 to the item recommendation computing device 102, requesting items to be recommended to the customer in the cart page. In some embodiments, the operations 410, 420 in FIG. 4 can be performed offline before receiving the recommendation request, and the other operations in FIG. 4 are performed in real-time after receiving the recommendation request.

One goal here is to recommend some items that the customer would like to place in the shopping cart. Treating existing items in the shopping cart as a sequence, the recommendation is to predict next likely items to be added into the sequence. As such, the disclosed method can be applied similarly to recommend items to be placed into a sequence of items during other interactions of the customer, e.g. items clicked, items viewed, items purchased, etc.

As shown in FIG. 4, the at least one anchor item can be sent to operations 440, 450 separately for predicting next likely items the customer would place in the shopping cart, or generally in a sequence. In this example, the operation 440 includes operations 442, 444, 446 performed to generate a list of product types that the customer would be interested in for the shopping cart. The operation 450 includes operations 452, 454, 456 performed to generate a list of virtual item types that the customer would be interested in for the shopping cart. In some embodiments, the operations 440 442, 444, 446 are performed in parallel to and/or independently of the operations 452, 454, 456.

In some embodiments, product type related data is obtained at the operation 442. For example, the product type related data may include a product type determined for each of the at least one anchor item placed in a sequence, e.g. for each item sequentially placed in the cart. At the operation 444, the next product types that the customer would like to place in the sequence are predicted. For example, the system may use a first machine learning model, e.g. a model based on the sequence based prediction model 396, to predict a first list of product types based on the product type(s) already in the sequence. In some examples, each respective predicted product type in the first list is associated with a first likelihood score representing a probability that the customer will enable an item of the respective product type to be placed as next item in the sequence. At the operation 446, a first ranked list of product types may be generated, e.g. by ranking the first list of product types based on their respective first likelihood scores.

In some embodiments, virtual item type related data is obtained at the operation 452. For example, the virtual item type related data may include a virtual item type determined for each of the at least one anchor item placed in a sequence, e.g. for each item sequentially placed in the cart. At the operation 454, the next virtual item types that the customer would like to place in the sequence are predicted. For example, the system may use a second machine learning model, e.g. a model based on the sequence based prediction model 396, to predict a second list of virtual item types based on the virtual item type(s) already in the sequence. In some examples, each respective predicted virtual item type in the second list is associated with a second likelihood score representing a probability that the customer will enable an item of the respective virtual item type to be placed as next item in the sequence. At the operation 456, a second ranked list of virtual item types may be generated, e.g. by ranking the second list of virtual item types based on their respective second likelihood scores.

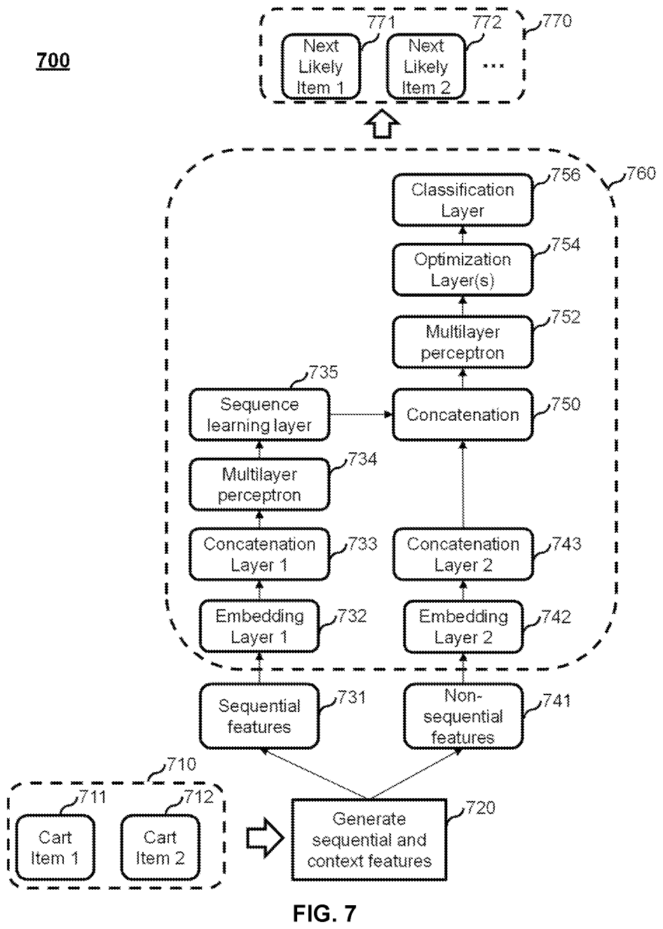

FIG. 7 illustrates an exemplary process 700 for predicting next likely items, in accordance with some embodiments of the present teaching. In some embodiments, the process 700 can be carried out by one or more computing devices, such as the prediction data computing device 102, and/or the cloud-based engine 121 of FIG. 1. In some embodiments, the process 700 may be a detailed process of the operation 440 and/or the operation 450 in FIG. 4.

As shown in FIG. 7, the process 700 starts from operation 720, where a sequence 710 of cart items 711, 712 are obtained and utilized to generate sequential and context features. In some embodiments, the sequential features generated at the operation 720 may include but not limited to features related to: item ID, item product type, item price band, item average rating, cart add times, etc. These sequential features can be input into a prediction model 760 as sequential features 731. In some embodiments, the context features generated at the operation 720 may include but not limited to features related to: customer price affinity, customer persona, customer device, and other affinities of the customer. These context features can be input into the prediction model 760 as non-sequential features 741.

In the example shown in FIG. 7, the prediction model 760 has a transformer-based architecture, and include multiple layers like embedding layers, concatenation layers, optimization layer(s) and classification layer(s). As shown in FIG. 7, the prediction model 760 includes an embedding layer 1 732 configured to generate embeddings based on the sequential features 731, and includes a concatenation layer 1 733 configured to generate concatenated embeddings for the sequential features 731. In addition, the prediction model 760 also includes an embedding layer 2 742 configured to generate embeddings based on the non-sequential features 741, and includes a concatenation layer 2 743 configured to generate concatenated embeddings for the non-sequential features 741.

In the example shown in FIG. 7, the prediction model 760 further includes a multilayer perceptron (MLP) module 734, which may include a neural network configured to understand the concatenated embeddings for the sequential features 731. The prediction model 760 also includes a sequence learning layer 735 configured to learn relationship and connections in the sequential data. At another concatenation layer 750, the prediction model 760 can concatenate the learned sequential data from the sequence learning layer 735 with the concatenated embeddings for the non-sequential features 741, to generate combined features.

In addition, the prediction model 760 further includes another MLP module 752 to further understand and learn the combined features; and includes one or more optimization layers 754 to perform machine learning optimizations, e.g. reducing training time and/or improving prediction accuracy. Further, a classification layer 756 in the prediction model 760 can generate a list 770 including next likely items 771, 772. In some embodiments, each of the next likely items 771, 772 is associated with a likelihood score representing a probability that the customer will place the item as next item in the sequence 710. The items 771, 772 are ranked in the list 770 according to their respective likelihood scores, e.g. with earlier items in the list 770 having higher likelihood being placed as next item in the sequence 710. When the sequence 710 represents a sequence of cart items in a shopping cart, a higher likelihood for an item means a higher probability that the customer will put the item in the shopping cart as next item or succeeding item.

In some embodiments, the prediction model 760 is trained to predict an accurate list of next likely items, given the items already existing in the sequence 710. In the example shown in FIG. 7, the sequence 710 has two items 711, 712. But in other examples, the sequence 710 can have any number of items, including one or more items.

In some examples, when the sequential features 731 and the non-sequential features 741 are provided at a granularity level of actual items, each of the next likely items 771, 772 is also predicted at the granularity level of actual items. In some examples, when the sequential features 731 and the non-sequential features 741 are provided at a granularity level of virtual item types, each of the next likely items 771, 772 is also predicted at the granularity level of virtual item types. In some examples, when the sequential features 731 and the non-sequential features 741 are provided at a granularity level of product types, each of the next likely items 771, 772 is also predicted at the granularity level of product types.

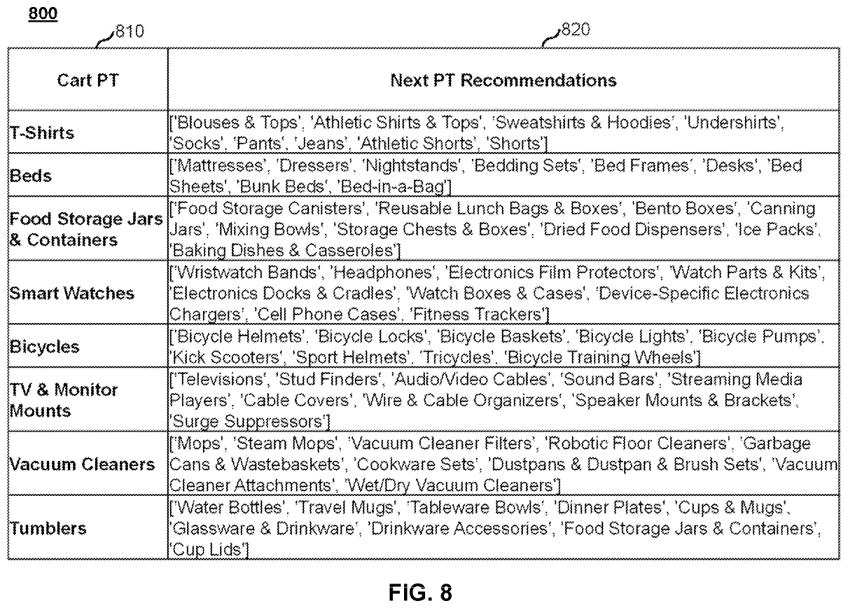

FIG. 8 shows a table 800 illustrating exemplary lists of recommended product types, in accordance with some embodiments of the present teaching. In the table 800, for a given cart product type in column 810, a list of next product type recommendations is shown correspondingly in column 820. For example, when the cart has a single item under the product type of T-shirts, a list of recommended product types includes: [‘Blouses & Tops’, ‘Athletic Shirts & Tops’, ‘Sweatshirts & Hoodies’, ‘Undershirts’, ‘Socks’, ‘Pants’, ‘Jeans’, ‘Athletic Shorts’, ‘Shorts’], as shown in FIG. 8. In some embodiments, these product type recommendations can be generated based on the prediction model 760 in FIG. 7, given the features of the product type of T-shirts in the cart. Similarly, the prediction model 760 can also generate virtual item type recommendations based on features of a virtual item type for the single item in the cart.

As such, the prediction model 760 in FIG. 7 utilizes a transformer architecture, which is particularly effective in handling sequential data and can capture long-range dependencies in the sequence of product types and virtual item types. In some embodiments, a primary function of the prediction model 760 is to predict the next likely product type or virtual item type that a customer might be interested in, based on the sequence of product types or virtual item types the customer has already added to the cart.

As discussed above, the system can utilize two of such complementary transformer-based models, both having an architecture like the prediction model 760, a first model for predicting product types and a second model for predicting virtual item clusters, to enhance the accuracy and relevance of recommendations. In some embodiments, the first model is trained based on data related to product types in historical user sessions and transactions of a plurality of customers; and the second model is trained based on data related to of virtual item types in historical user sessions and transactions of a plurality of customers. In some embodiments, the labels in the training data may be generated based on historical items sequentially placed in shopping carts by customers. For example, during a training process with five items in a cart, a model receives inputs of features about the first four items, and is trained to predict the fifth item in the cart, at different granularity levels.

Referring back to FIG. 4, the product types are predicted to generate a ranked product type list based on the operation 440, and the virtual item clusters or types are predicted to generate a ranked virtual item type list based on the operation 450. Then at operation 460, the two ranked lists are combined to generate a final ranked list of recommended items, to be displayed to the customer together with the at least one anchor item.

In some embodiments, a double validation mechanism is employed at the operation 460, where both models (for product types and for virtual item types) must agree for a product to be recommended, ensuring high-quality suggestions. That is, for a product to be placed in the final ranked list, the product must both belong to a product type in the ranked product type list and belong to a virtual item type in the ranked virtual item type list.

In some embodiments, the system can utilize the product type predictions from the ranked product type list to ensure category-level diversity. For example, a transformer-based model for predicting next product types can be used to recommend additional product types, given one product type in the sequence or in the cart. This would involve ensuring that the final recommendations from the operation 460 span a wide range of predicted product types. In some embodiments, the system use a weighted maximal marginal relevance model to combine the category diversification from the ranked product type list with relevance weights from the ranked virtual item type list.

In some examples, a weighted maximal marginal relevance model is used at the operation 460 to first generate a combined ranking list of virtual item types based on: the ranked product type list, the ranked virtual item type list, a first mapping, and a predetermined weight that balances relevance and diversity. The first mapping indicates a mapping relationship between product types and virtual item types. For each given virtual item type in the ranked virtual item type list, the first mapping can indicate a corresponding product type associated with the given virtual item type.

The final ranked list of recommended items can be generated at the operation 460 based on: the combined ranking list of virtual item types, a second mapping, and a time-adaptive factor that balances exploration and exploitation. The second mapping indicates a mapping relationship between actual items and virtual item types. For each given actual item, the second mapping can indicate a corresponding virtual item type associated with the given actual item. The time-adaptive factor can be used to identify one actual item for a recommended virtual item type, when multiple actual items are mapped to the recommended virtual item type.

In some examples, the system determines five virtual item types in the final ranked list. Each of the five virtual item types may be mapped to multiple actual items. The system can use the time-adaptive factor to pick one actual item for each virtual item type, to generate five recommended items to be displayed to the customer. Based on an adaptive objective of exploration and exploitation indicated by the time-adaptive factor, the system may determine pick different actual items for a given virtual item type, in different sessions, at different times, or for different customers.

In some examples, for every virtual item type, a list of top actual items associated to this virtual item type is determined at each moment. These actual items can be ranked based on popularity, title similarity and/or other rating features. The mapping can be generated offline before receiving any recommendation request. After predicting the next likely virtual item types, the system can convert them back to existing actual items to be recommended to the customers.

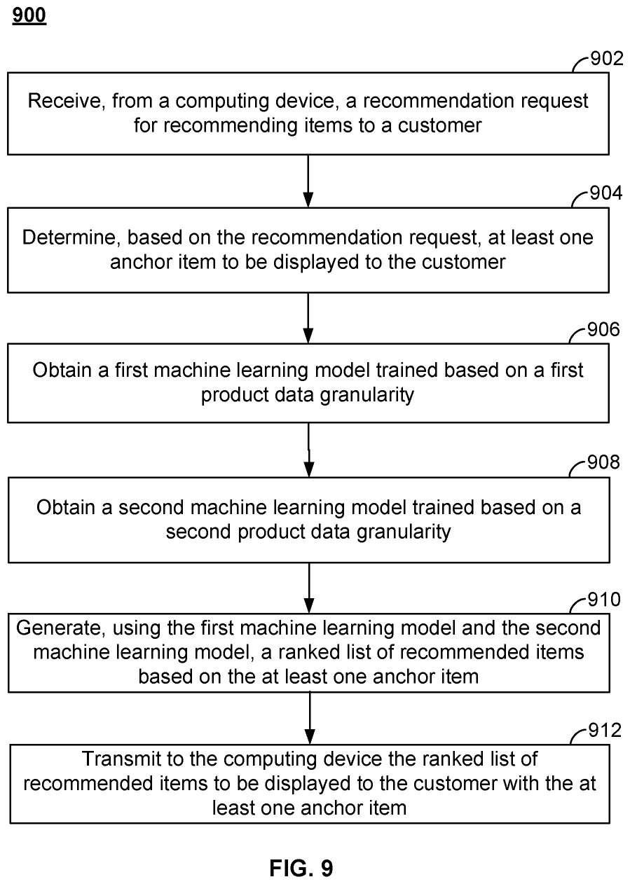

FIG. 9 is a flowchart illustrating an exemplary method 900 for providing item recommendations based on dual models with different levels of product data granularity, in accordance with some embodiments of the present teaching. In some embodiments, the method 900 can be carried out by one or more computing devices, such as the item recommendation computing device 102 and/or the cloud-based engine 121 of FIG. 1. Beginning at operation 902, a recommendation request for recommending items to a customer is received from a computing device. At operation 904, at least one anchor item to be displayed to the customer is determined based on the recommendation request. At operation 906, a first machine learning model trained based on a first product data granularity is obtained. At operation 908, a second machine learning model trained based on a second product data granularity is obtained. At operation 910, a ranked list of recommended items is generated using the first machine learning model and the second machine learning model based on the at least one anchor item. At operation 912, the ranked list of recommended items is transmitted to the computing device, to be displayed to the customer with the at least one anchor item.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
receive, from a computing device, a recommendation request for recommending items to a customer,
determine, based on the recommendation request, at least one anchor item to be displayed to the customer,
obtain a first machine learning model trained based on a first product data granularity,
obtain a second machine learning model trained based on a second product data granularity,
generate, using the first machine learning model and the second machine learning model, a ranked list of recommended items based on the at least one anchor item, and
transmit to the computing device the ranked list of recommended items to be displayed to the customer with the at least one anchor item.

2. The system of claim 1, wherein:
the second product data granularity is at a higher level of granularity than the first product data granularity.

3. The system of claim 2, wherein:
the first product data granularity is at a granularity level of product types;
the second product data granularity is at a granularity level of virtual item types;
a product type includes one or more virtual item types; and
a virtual item type includes one or more item identities (IDs) corresponding to one or more actual items respectively.

4. The system of claim 3, wherein the at least one processor is configured to:
determine a set of product types of a retailer;
determine a set of item IDs of the retailer, wherein each item ID belongs to one of the set of product types;
generate, using a large language model, a virtual catalog of virtual item types based on the set of product types and the set of item IDs;
determine, using the large language model, a first mapping between the set of product types and the virtual catalog of virtual item types; and
generate a second mapping between the set of item IDs and the virtual catalog of virtual item types.

5. The system of claim 4, wherein the second mapping is generated based on:
generating a virtual item embedding in an embedding space for each virtual item type in the virtual catalog; and
for each item ID in the set of item IDs:
generating an item embedding in the embedding space for the item ID,
computing a semantic similarity score between the item embedding and each virtual item embedding in the embedding space to generate a plurality of semantic similarity scores,
determining, in the plurality of semantic similarity scores, a highest semantic similarity score between the item embedding and a top virtual item embedding, and
mapping the item ID to a virtual item type having the top virtual item embedding.

6. The system of claim 4, wherein the ranked list of recommended items is generated based on:
determining at least one product type for the at least one anchor item placed in a sequence;
generating, using the first machine learning model, a first list of product types based on the at least one product type, wherein each respective product type in the first list is associated with a first likelihood score representing a probability that the customer will enable an item of the respective product type placed as next item in the sequence; and
ranking the first list of product types based on their respective first likelihood scores to generate a first ranked list.

7. The system of claim 6, wherein the ranked list of recommended items is generated based further on:
determining at least one virtual item type for the at least one anchor item placed in the sequence;
generating, using the second machine learning model, a second list of virtual item types based on the at least one virtual item type, wherein each respective virtual item type in the second list is associated with a second likelihood score representing a probability that the customer will enable an item of the respective virtual item type placed as next item in the sequence; and
ranking the second list of virtual item types based on their respective second likelihood scores to generate a second ranked list.

8. The system of claim 7, wherein the ranked list of recommended items is generated based further on:
generating, using a weighted maximal marginal relevance model, a combined ranking list of virtual item types based on: the first ranked list, the second ranked list, the first mapping, and a predetermined weight that balances relevance and diversity; and
generating the ranked list of recommended items based on: the combined ranking list of virtual item types, the second mapping, and a time-adaptive factor that balances exploration and exploitation.

9. The system of claim 3, wherein:
the first machine learning model and the second machine learning model are based on a same transformer architecture;
the first machine learning model is trained based on data related to product types in historical user sessions and transactions of a plurality of customers; and
the second machine learning model is trained based on data related to of virtual item types in historical user sessions and transactions of a plurality of customers.

10. The system of claim 1, wherein the at least one anchor item includes at least one of:
all item(s) clicked by the customer in a same user session;
all item(s) placed in a shopping cart by the customer in a same user session; or
all item(s) purchased by the customer via a same order.

11. A computer-implemented method, comprising:
receiving, from a computing device, a recommendation request for recommending items to a customer;
determining, based on the recommendation request, at least one anchor item to be displayed to the customer;
obtaining a first machine learning model trained based on a first product data granularity;
obtaining a second machine learning model trained based on a second product data granularity;
generating, using the first machine learning model and the second machine learning model, a ranked list of recommended items based on the at least one anchor item; and
transmitting to the computing device the ranked list of recommended items to be displayed to the customer with the at least one anchor item.

12. The computer-implemented method of claim 11, wherein:
the second product data granularity is at a higher level of granularity than the first product data granularity;
the first product data granularity is at a granularity level of product types;
the second product data granularity is at a granularity level of virtual item types;
a product type includes one or more virtual item types; and
a virtual item type includes one or more item identities (IDs) corresponding to one or more actual items respectively.

13. The computer-implemented method of claim 12, further comprising:
determining a set of product types of a retailer;
determining a set of item IDs of the retailer, wherein each item ID belongs to one of the set of product types;
generating, using a large language model, a virtual catalog of virtual item types based on the set of product types and the set of item IDs;
determining, using the large language model, a first mapping between the set of product types and the virtual catalog of virtual item types; and
generating a second mapping between the set of item IDs and the virtual catalog of virtual item types.

14. The computer-implemented method of claim 13, wherein generating the second mapping comprises:
generating a virtual item embedding in an embedding space for each virtual item type in the virtual catalog; and
for each item ID in the set of item IDs:
generating an item embedding in the embedding space for the item ID,
computing a semantic similarity score between the item embedding and each virtual item embedding in the embedding space to generate a plurality of semantic similarity scores,
determining, in the plurality of semantic similarity scores, a highest semantic similarity score between the item embedding and a top virtual item embedding, and
mapping the item ID to a virtual item type having the top virtual item embedding.

15. The computer-implemented method of claim 14, wherein generating the ranked list of recommended items comprises:
determining at least one product type for the at least one anchor item placed in a sequence;
generating, using the first machine learning model, a first list of product types based on the at least one product type, wherein each respective product type in the first list is associated with a first likelihood score representing a probability that the customer will enable an item of the respective product type placed as next item in the sequence; and
ranking the first list of product types based on their respective first likelihood scores to generate a first ranked list.

16. The computer-implemented method of claim 15, wherein generating the ranked list of recommended items further comprises:
determining at least one virtual item type for the at least one anchor item placed in the sequence;
generating, using the second machine learning model, a second list of virtual item types based on the at least one virtual item type, wherein each respective virtual item type in the second list is associated with a second likelihood score representing a probability that the customer will enable an item of the respective virtual item type placed as next item in the sequence; and
ranking the second list of virtual item types based on their respective second likelihood scores to generate a second ranked list.

17. The computer-implemented method of claim 16, wherein generating the ranked list of recommended items further comprises:
generating, using a weighted maximal marginal relevance model, a combined ranking list of virtual item types based on: the first ranked list, the second ranked list, the first mapping, and a predetermined weight that balances relevance and diversity; and
generating the ranked list of recommended items based on: the combined ranking list of virtual item types, the second mapping, and a time-adaptive factor that balances exploration and exploitation.

18. The computer-implemented method of claim 12, wherein:
the first machine learning model and the second machine learning model are based on a same transformer architecture;
the first machine learning model is trained based on data related to product types in historical user sessions and transactions of a plurality of customers; and
the second machine learning model is trained based on data related to of virtual item types in historical user sessions and transactions of a plurality of customers.

19. The computer-implemented method of claim 11, wherein the at least one anchor item includes at least one of:
all item(s) clicked by the customer in a same user session;
all item(s) placed in a shopping cart by the customer in a same user session; or
all item(s) purchased by the customer via a same order.

20. A non-transitory computer readable medium having instructions stored thereon, wherein the instructions, when executed by at least one processor, cause at least one device to perform operations comprising:
receiving, from a computing device, a recommendation request for recommending items to a customer;
determining, based on the recommendation request, at least one anchor item to be displayed to the customer;
obtaining a first machine learning model trained based on a first product data granularity;
obtaining a second machine learning model trained based on a second product data granularity;
generating, using the first machine learning model and the second machine learning model, a ranked list of recommended items based on the at least one anchor item; and
transmitting to the computing device the ranked list of recommended items to be displayed to the customer with the at least one anchor item.
